(19) United States
(12) Patent Application Publication
(10) Pub. No.: US 2004/0228996 A1
(43) Pub. Date: Nov. 18, 2004

(54) Multi-layer label products

(76) Inventor: Frank A. Franzo, Hawley, PA (US)

Correspondence Address: GREER, BURNS & CRAIN, LTD., Suite 2500, 300 South Wacker Drive, Chicago, IL, 60606, US

(21) Appl. No.: 10/752,616

(22) Filed: Jan. 7, 2004

Related U.S. Application Data
(60) Provisional application No. 60/469,668, filed on May 12, 2003.
(60) Provisional application No. 60/479,122, filed on Jun. 17, 2003.

(51) Int. Cl. B32B 9/00; B32B 33/00; B32B 31/00

(52) U.S. Cl. 428/40.1; 156/250; 156/267

(57) ABSTRACT

A multi-layer label for a bottle or a container is provided having a base label including an outer edge, and a first corner or other portion provided with permanent adhesive. The label also has an overlayer having a second outer edge and a second corner or other portion adhered to the base label at the outer edge and the first corner portion, respectively. A remaining portion of the overlayer is detached from the second corner portion such that the remaining portion is not permanently adhered to the base label at the first corner portion. Information may be printed on at least one of the first corner portion and the second corner portion during or after fabrication of the label such that damage to or removal of the remaining portion of the overlayer does not remove the printed information from the bottle or container: Further, where removal of either corner portion occurs, the tampering is evident.

This application claims priority under 35 U.S.C. §119 from Provisional Application Serial Nos. 60/469,668 filed on May 12, 2003 and 60/479,122 filed on Jun. 17, 2003, both titled Tamper-proof Label Products.

### FIELD OF THE INVENTION

This invention relates to multi-layer labels, and more particularly, to multi-layer labels in which information printed on the label after fabrication is preserved, even if one or more layers is removed.

### BACKGROUND OF THE INVENTION

Labels on products such as bottles or other containers, particularly containers holding medications, are routinely provided with multiple substrates that provide the pharmacist or the purchaser with information about the product. If only two substrates are used, the second substrate is generally attached to the first substrate, which in turn is directly adhered to the bottle.

Labels for containers may further be provided, with product information such as an expiration date and a lot number. This product information is generally provided at a point of manufacture of the product, not the point of manufacture of the label. Typically, this product information is printed on an exposed surface of the label after the label has been fabricated, either before or after the label is applied to the container. This is done both for ease of manufacturing processes as well as for unobstructed viewing of the printed information by the manufacturer, pharmacist or purchaser.

In a multi-layer label, the second substrate provides additional space for product information, such as symptoms treatable by the product and appropriate dosages. However, the second substrate is generally not directly adhered to the bottle or container, so it can be inadvertently or intentionally damaged or removed, leaving only the first substrate on the container. This is a problem if the expiration date or the lot number is printed on the second substrate. Such inadvertent or intentional removal of the substrate, and the product information printed thereon, may render the product unfit for sale. Further, it is not always evident that the second substrate containing such information has been removed, which can lead to an accidental sale of the product.

Thus, there is a need for a multi-layer label, and a method for making such a label, which allows product information, such as the expiration date and the lot number, to be printed on an exposed label surface after the label has been fabricated, and preserves the information even if the second substrate is removed from the container.

Accordingly, one object of this invention is to provide a new and improved method and apparatus for multi-layer labels.

Another object is to provide new and improved multi-layer labels in which information printed on the label after fabrication is preserved, even if one or more layers is removed.

### SUMMARY OF THE INVENTION

In keeping with one aspect of the invention, a base label has pressure sensitive adhesive on one side and permanent adhesive along an outer edge of the other side. An overlayer is adhered to the outer edge of the base label along a second outer edge of the overlayer. The base label and overlayer are typically flush cut.

The base label also has a corner or other portion, usually opposite the outer edge, which is permanently adhered to a corresponding second corner or other portion of the overlayer. A remaining portion of the overlayer is not permanently adhered to the base label and is detached from the second corner portion so that the second portion remains even if the remaining portion is lifted and/or removed.

In an alternate embodiment, the second corner portion of the overlayer is detached from the remaining portion, not adhered to the base label corner portion, and removed so that printed information printed on the base label corner portion after fabrication is preserved even after the remaining portion of the overlayer is lifted and/or removed.

The multi-layer label can be made by moving a web of label stock along a path. The label stock can be plain paper, or it can have pressure sensitive adhesive on one side, with a release liner covering the pressure sensitive adhesive. Permanent adhesive is applied along at least a succession of spaced portions on the other side of the label stock, and a web of overlay material is placed over the other side of the label stock and is adhered to at least the spaced portions of the label stock. The label stock and the overlay are die-cut into a succession of individual labels having a desired size and a resulting waste matrix, which is removed. The labels are usually flush cut. The labels are die-cut such that the spaced portions are located along a first edge of the labels. The overlay is also die-cut to form a succession of corner or other portions detached from the rest of the label. The corresponding overlay corner or other portions can be removed or permanently adhered to the base labels.

### BRIEF DESCRIPTION OF THE DRAWINGS

FIG. 1 is a top view of a label product made in accordance with the present invention;

FIG. 2 is a side view of the label product of FIG. 1;

FIG. 3 is a diagram illustrating the manufacturing process used to make the product of FIG. 1;

FIG. 4 is a top view of another embodiment of a label product made in accordance with the present invention;

FIG. 5 is a side view of the label product of FIG. 4; and

FIG. 6 is a diagram illustrating the manufacturing process used to make the product of FIG. 4.

### DETAILED DESCRIPTION

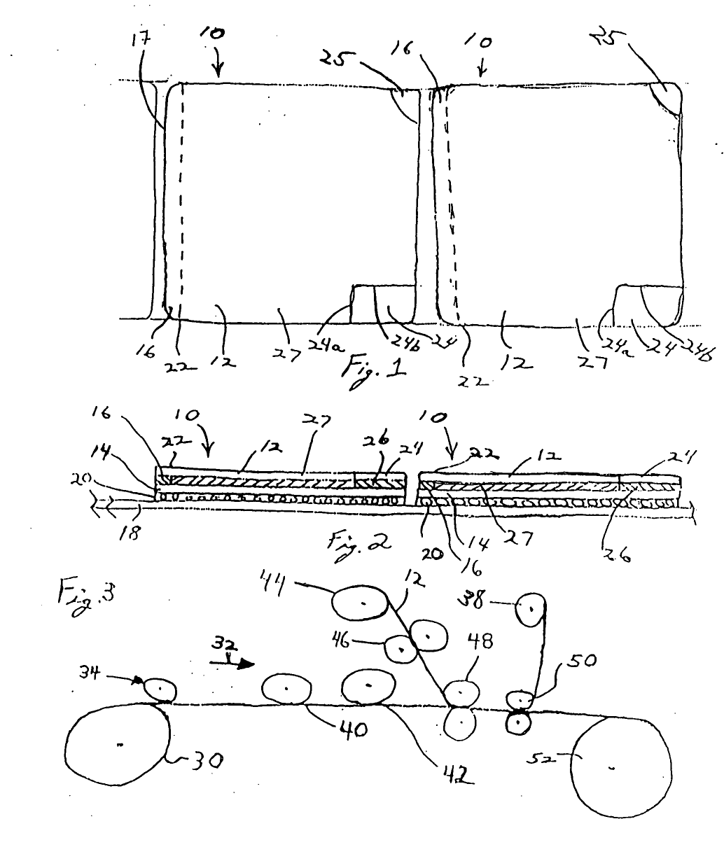

One embodiment of the present invention is shown in FIGS. 1 and 2. A label 10 includes an overlayer 12 secured to a base label 14 by permanent adhesive 16, which extends along one edge 17 of the label 10. The permanent adhesive 16 effectively forms a hinge 22 along the edge of the overlayer 12.

The base label 14 is temporarily secured to a release liner 18 by a layer of pressure sensitive adhesive 20. When the release liner is removed, the base label can be permanently attached to a carton, a bottle, or other container, etc.

A portion 27 of the overlayer 12 is releasably adhered to the base label 14 by applying removable adhesive or deadener to the portion 27. Alternatively, the portion 27 need not be adhered to the base label 14.

One corner portion 24 of the overlayer 12 is die-cut and permanently adhered to the base label 14 by permanent adhesive 26, and another corner can have a peel tab 25, if desired. The corner 24 can be any desirable size, but is large enough to contain desired printed information, such as the lot number or other identification of a drug. While the portion 24 is shown in a corner, it could be along an edge or in the interior of the label, as well.

The printed information is retained on the label even if the overlayer is removed. Tampering by removal of the corner piece 24 would be apparent and easily discovered.

The corner portion 24 can be eliminated by printing the desired information directly on the base label 14 in a selected area of the label, such as the area under the corner portion 24. The corner portion 24 can be placed on the base label with no adhesive, temporary adhesive, adhesive covered by deadener, or the like. The corner portion 24 can then be die-cut and removed.

The label of FIGS. 1 and 2 can be made using the apparatus shown in FIG. 3. A reel of label stock 30 is unwound along a path 32. The label stock can be printed at any suitable place early in the process, such as at one or more print stations 34.

Permanent adhesive can be applied across the entire base label areas, or the entire label stock, at a station 40, and the portion 27 can be deadened at a deadening station 42, leaving the portion 16 and the area under the corner piece 24 with exposed permanent adhesive. The deadener makes the overlay portion 27 releasable and resealable. It is also contemplated that the permanent adhesive could be applied in a suitable pattern, with removable adhesive applied to the portions 27 at station 42. Alternatively, no adhesive need be applied to portions 27.

The portion of the base label peel tab portion 25 can be prepared in the same manner, i.e., by coating first with permanent adhesive and then with an appropriate deadener, or by patterning the permanent adhesive or not placing adhesive under the peel tab 25.

A web of overlay material 12 is unwound from a reel 44 and printed on one or both sides at one or more printing stations 46. The web overlay material is adhered to the label stock at a nip roller station 48, and the resulting base labels are die-cut at a station 50, which also die-cuts the corner piece 24. The label is typically flush cut.

All four sides of corner portion 24 should be die-cut if the corner portion is permanently adhered to the base label, but only interior sides 24a, 25b need be cut if the cover portion is to be removed with the waste matrix or waste material. In any event, the waste material, which can include the corner piece 24, is removed to a station 38. The finished label products 10 are wound around a reel 52.

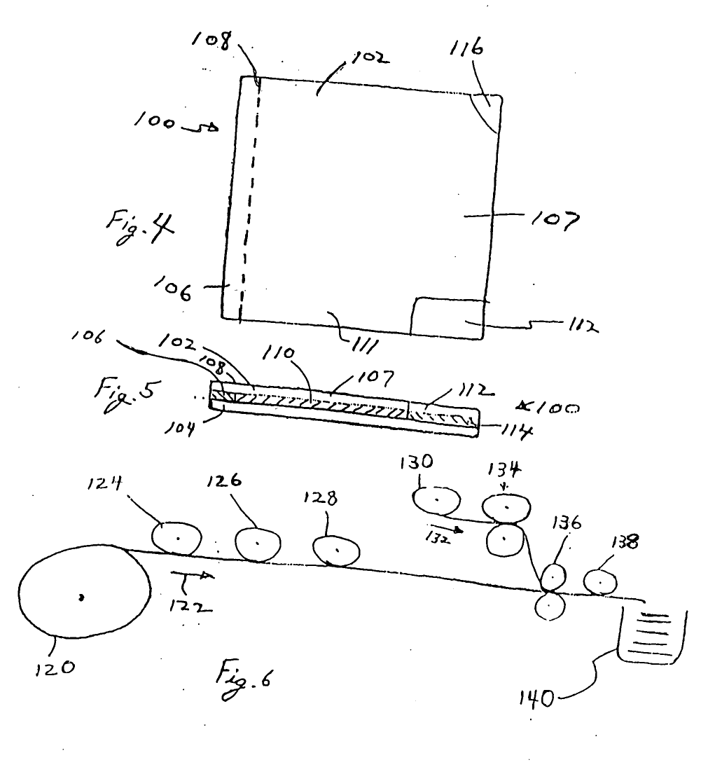

A second embodiment in the invention is shown in FIGS. 4 and 5. A label product 100 includes an overlay 102 secured to a piece of paper stock or the like 104 with permanent adhesive 106, which extends along one edge of the overlay 102 to form a hinge 108. Temporary adhesive 110 releasably and resealably secures a portion 107 of the overlay to the paper stock 104. Alternatively, no adhesive need be applied to the portion 107.

A corner or other portion 112 of the overlay 102 is die-cut, and adhered to the paper stock 104 by permanent adhesive 114. In this manner, the overlay 102 can be lifted, without removing the corner 112. Tampering with the corner portion 112, which is printed with essential information, such as lot number, drug type, etc., is evident because tampering is destructive.

The corner portion 112 could also be removed, as previously described. A peel tab 116 can also be provided, if desired.

The label of FIGS. 4 and 5 is made in the manner shown in FIG. 6. A reel of paper stock 120 is unrolled along a path 122. It can be printed at one or more print stations 124, if desired, and permanent adhesive is applied at a station 126. The portion 110 of the adhesive can be deadened in a pattern at an adhesive deadener station 128. The permanent adhesive can also be applied in patches, with releasable adhesive applied at the portion 111. The peel tab 116 can be prepared in the manner previously described. In any event, the labels can be made continuously along the reel of paper stock, or they can be spaced from each other. The corner portion 112 can be removed in the die-cutting operation, if desired, in the manner described.

A web of overlay material 130 is unwound along a path 132 and printed on one or both sides at one or more printing stations 134. The overlay material is married to the paper stock at nip rollers 136, and the resulting web is die-cut at a station 138 to produce finished label products 140, stacked on top of each other, as in FIG. 6, or stacked under each other.

As with the first embodiment, the corner 112 can be printed with essential material such as lot information, etc., so that the essential information cannot be removed without destroying the label.

The essential material can be printed on the corner portions of the overlay after the label is fabricated, if desired. Since the corner portion is detached from the rest of the overlay, the corner portion is not removed, even if the overlay is torn off and discarded. If the corner portion of the overlay is removed during label fabrication, the essential material can be printed on the exposed corner of the underlying base label. In this case also, the essential material is preserved even if the overlay is removed.

While the principles of the invention have been described above in connection with specific apparatus and applications, it is to be understood that this description is made only by way of example and not as a limitation on the scope of the invention.

What is claimed is:

1. A multi-layer label comprising:
a base label including a first side having permanent adhesive on at least a first outer edge and a first portion outside the first outer edge; and
an overlayer including a second outer edge and a second portion permanently adhered to the first side of the base label at the first outer edge and the first portion, respectively;
a remaining portion of the overlayer not being permanently adhered to the base layer, the remaining portion being detached from the second portion of the overlayer.

2. The multi-layer label of claim 1 further comprising a pressure sensitive adhesive on a second side of the base label and a release liner covering the pressure sensitive adhesive.

3. The multi-layer label of claim 1 wherein the base label has printed matter on at least the first side.

4. The multi-layer label of claim 1 wherein the second portion has printed matter on at least its exposed side.

5. The multi-layer label of claim 1 wherein the overlayer has printed matter on at least the first side.

6. The multi-layer label of claim 1 wherein the base label beneath the remaining portion of the overlayer has adhesive and a deadener layer, whereby the remaining portion is not permanently adhered to the base label.

7. The multi-layer label of claim 1 wherein the base label beneath the remaining portion of the overlayer has no adhesive, whereby the remaining portion is not permanently adhered to the base label.

8. The multi-layer label of claim 1 wherein the base label has an adhesive pattern, whereby the remaining portion is not permanently adhered to the base label.

9. The multi-layer label of claim 1 wherein the overlayer is die-cut to detach the second portion from the remaining portion.

10. The multi-layer label of claim 1 further comprising a peel tab disposed on the overlayer.

11. The multi-layer label of claim 1 wherein the first and second portions are corner portions.

12. A multi-layer label comprising:
a base label having a first side with a first portion and permanent adhesive on a first outer edge outside of the first portion; and
an overlayer having a first side including a second outer edge permanently adhered to the first side of the base label at the first outer edge;
wherein a remaining portion of the overlayer is not permanently adhered to the base label, and the first portion of the base label is not covered by the overlayer.

13. The multi-layer label of claim 12 further comprising pressure sensitive adhesive on a second side of the base label and a release liner covering the pressure sensitive adhesive.

14. The multi-layer label of claim 12 wherein the base label has printed matter on at least the first side.

15. The multi-layer label of claim 12 wherein the first portion has printed matter on at least the first side.

16. The multi-layer label of claim 12 wherein the overlayer has printed matter on at least the first side.

17. The multi-layer label of claim 12 wherein the base layer beneath the remaining portion of the overlayer has adhesive and a deadener layer, whereby the remaining portion is not permanently adhered to the base layer.

18. The multi-layer label of claim 12 wherein the base layer beneath the remaining portion of the overlayer has no adhesive, whereby the remaining portion is not permanently adhered to the base layer.

19. The multi-layer label of claim 12 wherein the base label has an adhesive pattern, whereby the remaining portion is not permanently adhered to the base layer.

20. The multi-layer label of claim 12 further comprising a peel tab disposed on the overlayer.

21. The multi-layer label of claim 12 wherein the first portion is in a corner of the base label.

22. A method for manufacturing a multi-layer label comprising the steps of:
moving a web of label stock along a path;
applying permanent adhesive along at least a succession of spaced portions of a first side of the label stock;
adhering an overlay to at least the spaced portions of the label stock;
die-cutting the overlay to form a succession of second portions detached from a succession of remaining portions of the overlay; and
separately or simultaneously die-cutting the label stock and overlay into a succession of individual labels having a desired size.

23. The method of claim 22 comprising the steps of applying permanent adhesive to the first side of the label stock at a succession of third portions and adhering the second portions of the overlay to the third portions.

24. The method of claim 22 comprising the step of applying removable adhesive to the remaining portions not adhered to the label stock, the remaining portions being detached from the second portions of the overlay.

25. The method of claim 22 comprising the steps of applying permanent adhesive to the entire first side of the label stock and deadening the adhesive on the remaining portions of the label stock.

26. The method of claim 22 comprising the step of printing the overlay on at least the first side.

27. The method of claim 22 comprising the step of printing the label stock on at least the first side.

28. The method of claim 22 wherein the overlay is die-cut along four sides of the corner portions and the corner portions are removed with the waste matrix.

29. The method of claim 22 wherein the overlay is die-cut along four sides of the corner portions and the corner portions are adhered to the label stock.

30. The method of claim 22 wherein the label stock has pressure sensitive adhesive on a second side of the label stock and a release liner covering the pressure sensitive adhesive, the die-cutting step not cutting the release liner.

31. The method of claim 22 wherein the overlay material is adhered to the label stock by nip rollers.

32. The method of claim 22 wherein the spaced portions and the second portions are located in a corner of the labels.

33. The method of claim 22 wherein the labels are flush cut.
